(19) United States
(12) Patent Application Publication
(10) Pub. No.: US 2003/0210231 A1
(43) Pub. Date: Nov. 13, 2003

(54) Computer peripheral with flash memory function

(76) Inventor: Wei Hsu, Taiper Hsien (TW)

Correspondence Address: Wei Hsu, 235 Chung-Ho, Box 8-24, Taipei, TW

(21) Appl. No.: 10/141,674

(22) Filed: May 9, 2002

(51) Int. Cl. G09G 5/08

(52) U.S. Cl. 345/163

(57) ABSTRACT

A circuit of a computer peripheral comprises a microprocessor, a built-in flash memory chip, a multi-joint plug; a USB communication interface processor; a power source, an indicator; and selecting button, and a peripheral function sensor. The flash memory chip is built-in or plug-into the peripheral device. Data can be transferred between the computer and the flash memory chip through the USB communication interface processor, but the peripheral still works; when the peripheral is separated from the computer, the data still stores therein. Thereby, the data storage capacity can be increased and the flash memory device can be combined with the peripheral device so as to reduce the volume.

### FIELD OF THE INVENTION

The present invention relates to computer peripheral devices, and particularly to a computer peripheral with flash memory function, which includes a plug-plug USB port, and can store data therein.

### BACKGROUND OF THE INVENTION

In order to increase the data storage capacity, usually, external memory device is used to plug into a computer device for auxiliary recording data. Moreover, the external device is portable so that the data stored in the memory device can be transferred to other device for reading out. Nowadays, flash memory device is a popular memory device due to larger capacity and quick storage speed. The flash memory is made as a flash memory card which can be plugged into a slot of a computer.

However, the user must carry the flash memory card. This is inconvenient. In general, a computer device is unavoidably connected with other peripherals, such as a mouse, a joystick, a digital camera, etc. Thereby, if the user want to carry the memory card, he (or she) must carry two objects, one peripheral device and one memory card. However, this further increases the inconvenience of the user. It is often that the user forgets to carry of the them so that he (or she) can not work successfully and easily.

Thereby, the ideal of the present invention is to combine the two functions in one device so as to resolve the inconvenience of the prior art.

### SUMMARY OF THE INVENTION

Accordingly, the primary object of the present invention is to provide a computer peripheral with flash memory function, which can store data and have the original function of the peripheral.

To achieve above objects, the present invention provides a circuit of a computer peripheral comprises a microprocessor, a built-in flash memory chip, a multi-joint plug; a USB communication interface processor; a power source, an indicator; and selecting button, and a peripheral function sensor.

In use, a personal computer or a notebook computer is connected to the peripheral of the present invention through a USB connector. Then the drive for driving the peripheral is installed into the computer. Thereby, the data can be stored in the computer of the flash memory chip (which is a built-in or plug-in device) of the present invention. Moreover, the data stored in the peripheral can be transferred to the computer, but the mouse still works normally. When the external peripheral is separated from the computer; the data stored in the peripheral will not disappear so as to be stored for a longer time. Therefore, the peripheral 1 can be used as an auxiliary memory device and thus a large amount of data can be stored independent of the stored medium in the mainframe. Not only the cost and expense for buying the storage medium can be reduced, but also the trouble from carrying a storage medium can be reduced.

The various objects and advantages of the present invention will be more readily understood from the following detailed description when read in conjunction with the appended drawing.

### BRIEF DESCRIPTION OF THE DRAWINGS

FIG. 1 is a circuit block diagram of a preferred embodiment of the present invention.

FIG. 2 is a circuit block diagram of another preferred embodiment of the present invention.

FIG. 3 is a circuit block diagram of a yet embodiment of the present invention.

FIG. 4 is a circuit block diagram of a still embodiment of the present invention.

FIG. 5 is a schematic view showing an internal structure of an embodiment of the present invention.

FIG. 6 is a perspective view of FIG. 5.

FIG. 7 is a structural perspective view of one embodiment of the present invention.

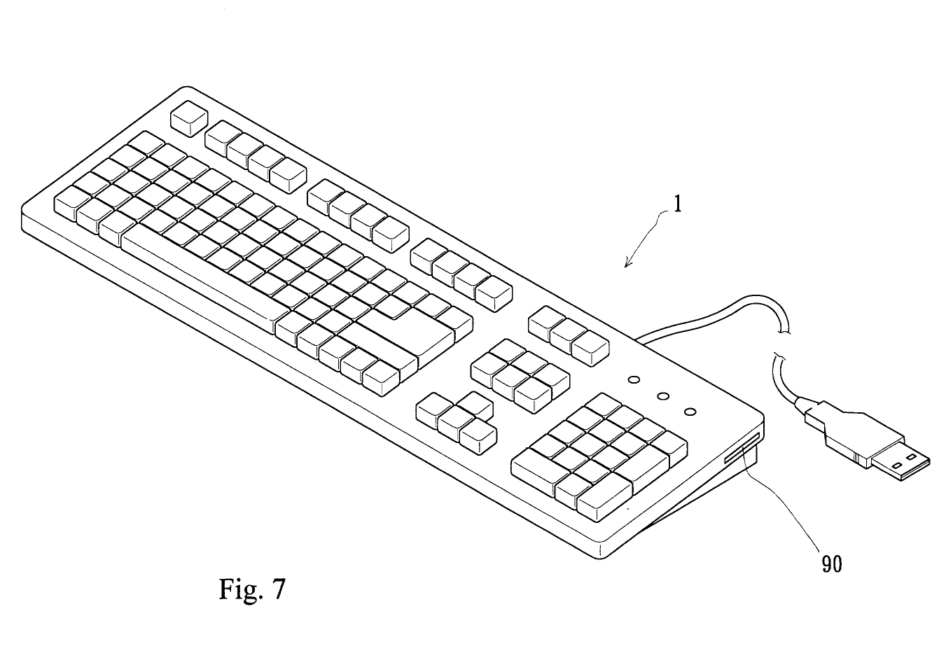

FIG. 8 is a structural perspective view of one embodiment of the present invention.

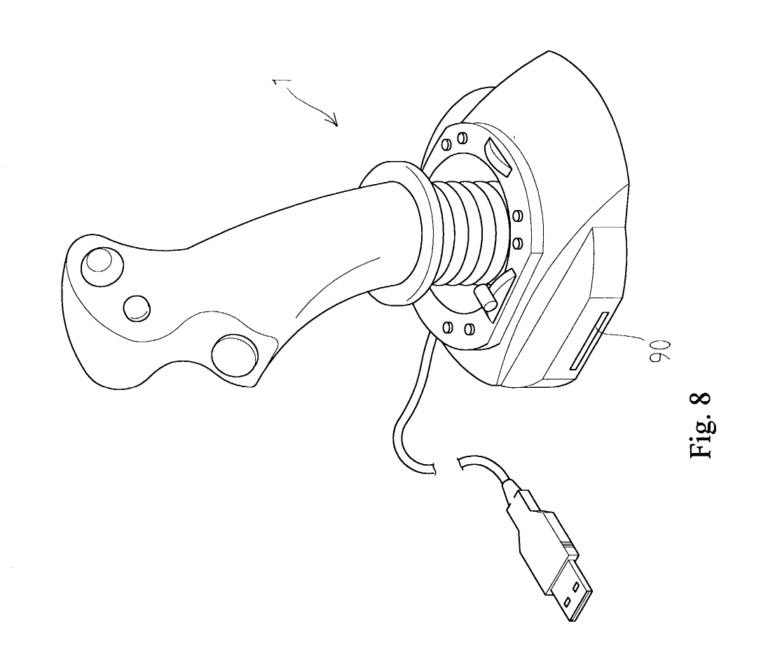

FIG. 9 is a structural perspective view of one embodiment of the present invention.

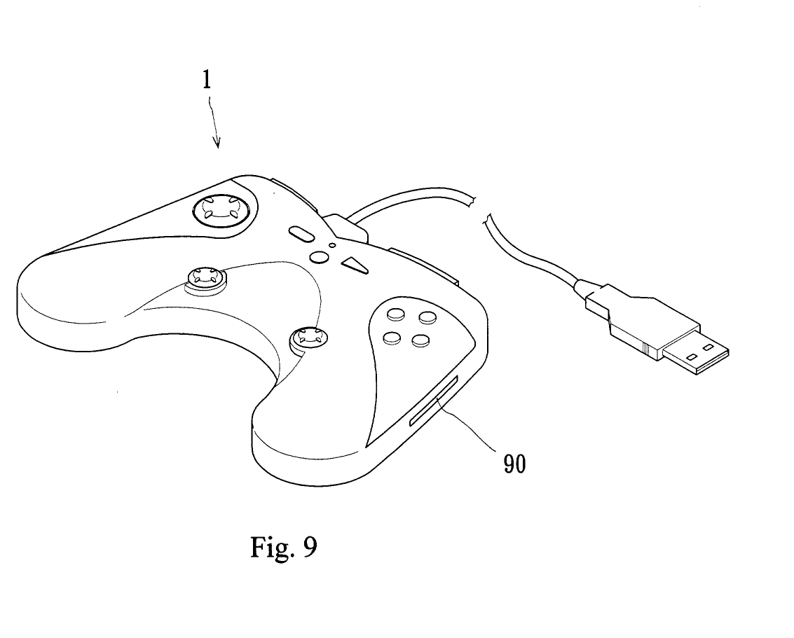

### DETAILED DESCRIPTION OF THE PREFERRED EMBODIMENTS

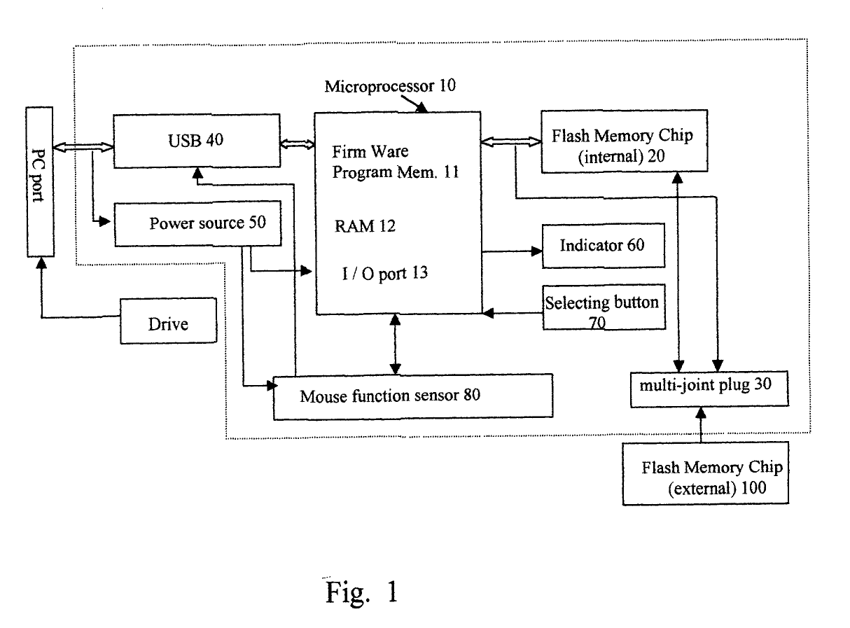

Referring to the appended drawings, the computer peripheral with flash memory function of the present invention is illustrated. The computer peripheral 10 may be one of a mouse, a keyboard, a joystick, PC digital camera, etc. The circuit of the computer peripheral is illustrated in FIG. 1. The circuit includes the following elements.

A microprocessor 10 has a firmware program memory 11, a random access memory and an input/output port 13.

A built-in flash memory chip 20 is interconnected to the microprocessor 10.

A multi-joint plug 30 serves for being inserted by a flash memory card 100 and is connected to the flash memory chip 20.

A USB communication interface processor 40 serves to be connected to a USB port of a computer 200 and is connected with the microprocessor 10. The USB communication interface processor 40 has the function of “plug and play”.

A power source 50 is connected to the USB communication interface processor 40, computer USB port 200 and a peripheral function sensor 80.

An indicator 60 serves to illustrate that the peripheral function sensor 80 has combined with a computer and a USB has been inserted, or illustrate that data has transferred. The indicator 60 is LED.

A selecting button 70 is connected to the microprocessor 10.

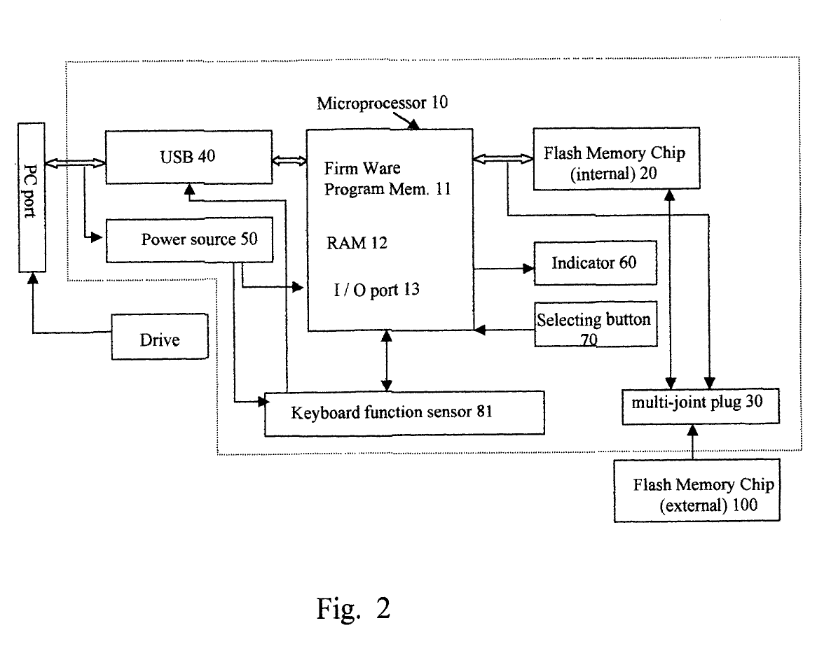

The peripheral function sensor 80, 81, 82 or 83 is connected to the microprocessor 10, USB communication interface processor 40 and power source 50. The peripheral function sensor 80 can be changed. For example, if the present invention is used to a mouse, the peripheral function sensor 80 is a mouse function sensor. Similarly, it can be used to a keyboard, joystick, handle-type controller, etc., as shown in FIGS. 2, 3 and 4.

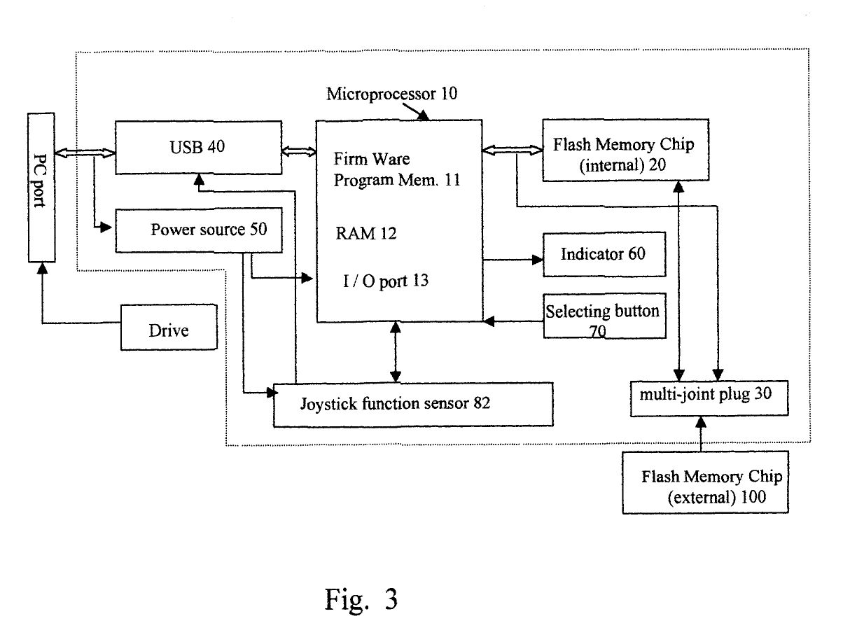

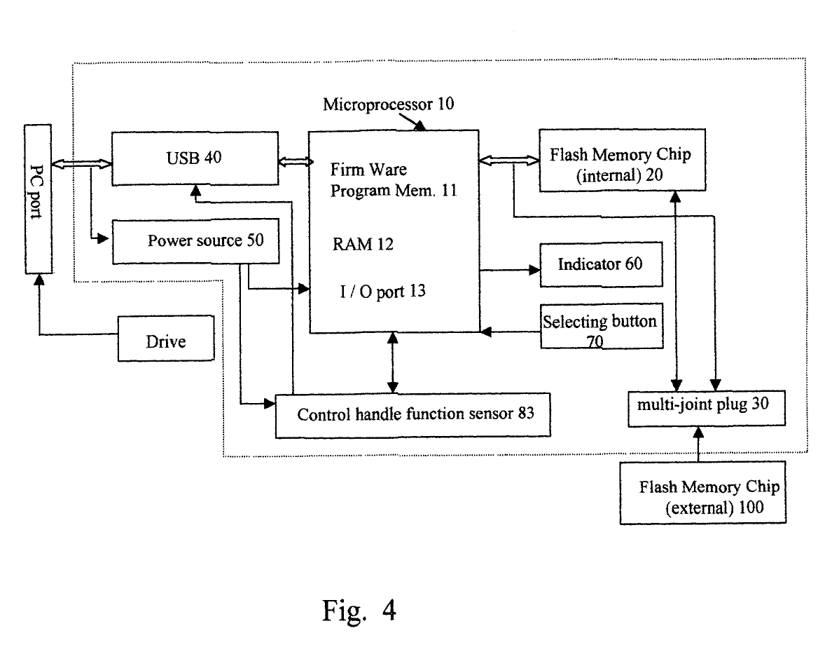

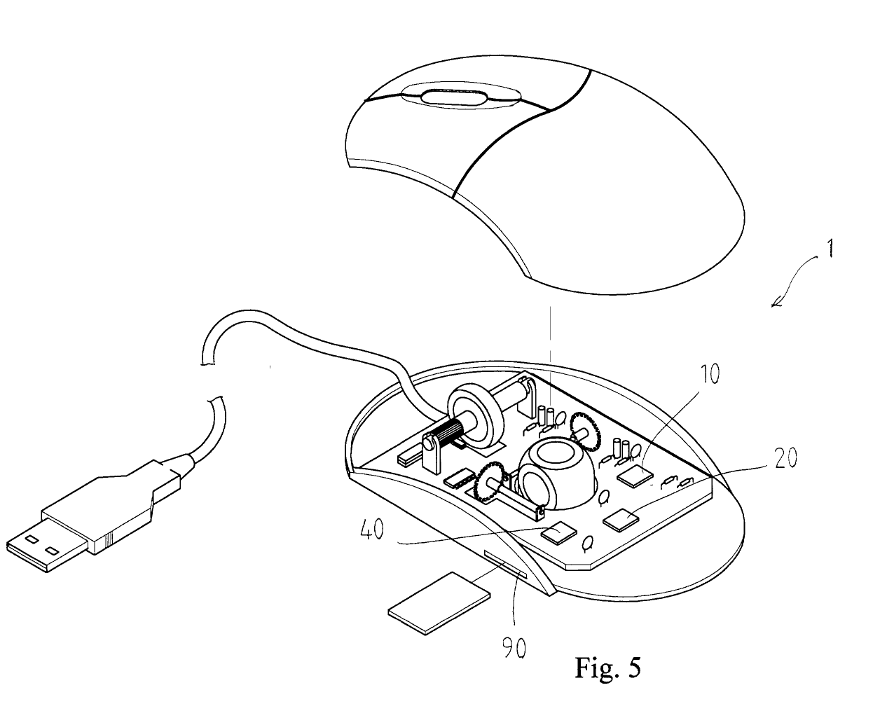

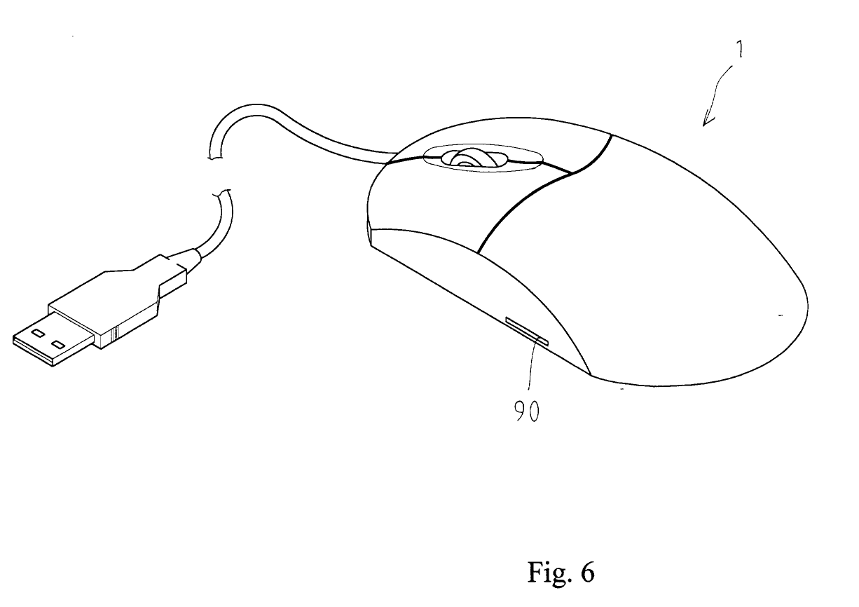

FIGS. 5 and 6 shows that the present invention is used other peripherals. For example when the present invention is utilized to a mouse, the control program of a mouse is combined with the present invention. As shown in the figures, other than the basic components in a mouse, the circuit of the mouse includes a microprocessor 10, a built-in flash memory chip 20, a multi-joint plug 30 (plug-in flash memory card), a USB communication interface processor 40, etc. The external joint is matched with the USB joints. The casing of the mouse has a slot 90. Likewise, the same structure can be used in the circuit of a keyboard 81 (in FIG. 2), joystick 82 (in FIG. 3), controller handle (in FIG. 4), etc.

Above mentioned flash memory chip can be externally or internally installed in the computer peripherals.

In use, a personal computer or a notebook computer is connected to the peripheral 1 of the present invention through a USB connector. Then the drive for driving the peripheral 1 is installed into the computer. Thereby, the data can be stored in the computer of the flash memory chip (which is a built-in or plug-in device) of the present invention. Moreover, the data stored in the peripheral can be transferred to the computer, but the mouse still works normally. When the external peripheral 1 is separated from the computer 1, the data stored in the peripheral 1 will not disappear so as to be stored for a longer time. Therefore, the peripheral 1 can be used as an auxiliary memory device and thus a large amount of data can be stored independent of the stored medium in the mainframe. Not only the cost and expense for buying the storage medium can be reduced, but also the trouble from carrying a storage medium can be reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A circuit of a computer peripheral comprising:
a microprocessor having a firm ware program memory, a random access memory and an input/output port;
a built-in flash memory chip interconnected with the microprocessor;
a multi-joint plug connected to the flash memory chip for being inserted by a flash memory card;
a USB communication interface processor connected with the microprocessor and a USB port of a computer; the USB communication interface processor having the function of plug and play;
a power source connected to the USB communication interface processor, computer USB port and a peripheral function sensor for supplying power;
an indicator for displaying a standby status and a data transfer status;
a selecting button connected to the microprocessor;
a peripheral function sensor connected to the microprocessor, the USB communication interface processor and power source;
wherein data can be transferred between the computer and the flash memory chip through the USB communication interface processor, but the peripheral still works; when the peripheral is separated from the computer, the data still stores therein.

2. The computer peripheral with flash memory function as claimed in claim 1, wherein the peripheral is selected from one of a mouse, a keyboard, a joystick, a play control handle, and a PC digital camera.

3. The computer peripheral with flash memory function as claimed in claim 1, wherein the flash memory chip is externally installed in the peripheral.

4. The computer peripheral with flash memory function as claimed in claim 2, wherein the flash memory chip is internally installed in the peripheral.
